(19) United States
(12) Patent Application Publication
(10) Pub. No.: US 2006/0274752 A1
(43) Pub. Date: Dec. 7, 2006

(54) Method and apparatus for managing address resolution protocol data for interfaces connected to different switches

(76) Inventors: Vinit Jain, Austin, TX (US); Rashmi Narasimhan, Austin, TX (US); Venkat Venkatsubra, Austin, TX (US)

Correspondence Address: IBM CORP (YA);C/O YEE & ASSOCIATES PC, P.O. BOX 802333, DALLAS, TX, 75380, US

(21) Appl. No.: 11/146,442

(22) Filed: Jun. 6, 2005

(51) Int. Cl. H04L 12/28

(52) U.S. Cl. 370/392; 370/401

(57) ABSTRACT

A method, apparatus, and computer instructions code for sending data to a destination. A set of address resolution protocol entries is searched for an entry matching an Internet Protocol address for the destination and a particular interface in response to selecting the particular interface from a set of interfaces in the data processing system to send the data to the destination. The destination has a plurality of interfaces using the Internet Protocol address with each interface in the plurality of interfaces having a different media access control address. In response to a presence of the entry in the set of address resolution protocol entries, a media access control address in the entry is used to send the data to the destination.

### BACKGROUND OF THE INVENTION

1. Technical Field

The present invention relates generally to an improved data processing system and in particular to a method and apparatus for sending data across a network. Still more particularly, the present invention relates to a method, apparatus, and computer instructions for sending data to a remote data processing system through multiple interfaces.

2. Description of Related Art

Data is commonly transferred between different data processing systems across a network. In transferring data from one data processing system to another data processing system, a protocol called address resolution protocol (ARP) is employed. ARP is a network protocol, which maps a network layer protocol address to a data link layer hardware address. For example, ARP is used to resolve an Internet Protocol (IP) address to a corresponding Ethernet address. More information on ARP may be found in RFC826, An Ethernet Address Resolution Protocol, November 1982. A data processing system on an Ethernet network may communicate with another data processing system, only if it knows the Ethernet address of the target or destination data processing system. This Ethernet address is also referred to as a media access control (MAC). A MAC address is a hardware address that uniquely identifies each node of a network. For example, each network interface card (NIC) has a different MAC address. The higher level protocols, such as IP, use a different type of addressing scheme, such as NIP address, from the lower hardware level addressing scheme, such as a MAC address. ARP is employed to get the MAC address of a data processing system from its IP address.

Currently, ARP is extensively used by all data processing systems on an Ethernet network. An IP address needs to be mapped to a MAC address because the length of a MAC address is six bytes and the length of an IP address is four bytes. A MAC address cannot be represented using an IP address. Thus, an IP address is mapped to a corresponding MAC address. Further, ARP is a general protocol, which may be used for any type of broadcast network and is not limited to Ethernet networks.

When a given IP address is to be resolved to an Ethernet address, such as a MAC address, an ARP request packet is broadcast onto the network. This ARP request packet contains the source MAC address, the source IP address, and the destination IP address. Each host in the network receives this packet. A host within the specified destination IP address sends a reply ARP to the source with its IP address. This reply packet contains a MAC address for the destination.

The current implementations of ARP provide for efficient transfer of data in most cases. In the case of a data processing system having multiple interfaces with the same IP address, the current mechanisms using ARP sometimes result in delays or a failure to transfer data from a source to a destination. For example, in some configurations, a destination data processing system may have a single IP address assigned to two NICs in which each NIC is connected to a different switch on a different subnet. A subnet is a division of a network into an interconnected, but independent, segment, or domain. This type of division is typically employed to improve performance or security for a network. A source data processing system may contain two interfaces in the form of NICs in which these NICs also are connected to different switches in the different subnets.

When the source data processing system decides to send data to the destination data processing system, the source data processing system may choose two routes based on the two different NICS. Each route flows through a different switch to the destination. If the source data processing system chooses the first switch, an ARP request is sent out on that interface. The NIC on the destination connected to the same switch will respond with an ARP reply containing the MAC address of that NIC. At that point, data transfer may occur between those two NICs on the destination and source data processing system.

If that NIC on the destination data processing system fails, the same NIC will attempt to send data to that destination data processing system using the MAC address of the failed NIC. As a result, the data will not be accepted at the destination. As a result, data transfer halts because the source data processing system is unable to send data to the destination.

Therefore, it would be advantageous to have an improved method, apparatus, and computer instructions for transferring data using ARP.

### SUMMARY OF THE INVENTION

The present invention provides a method, apparatus, and computer instructions code for sending data to a destination. A set of address resolution protocol entries is searched for an entry matching an Internet Protocol address for the destination and a particular interface in response to selecting the particular interface from a set of interfaces in the data processing system to send the data to the destination. The destination has a plurality of interfaces using the Internet Protocol address with each interface in the plurality of interfaces having a different media access control address. In response to a presence of the entry in the set of address resolution protocol entries, a media access control address in the entry is used to send the data to the destination.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server depicted in accordance with a preferred embodiment of the present invention;

FIG. 3 is a block diagram illustrating a data processing system depicted in which the present invention may be implemented;

FIG. 4 is a typical software architecture for a server-client system depicted in accordance with a preferred embodiment of the present invention;

FIG. 5 is a diagram of a transmission control protocol/Internet Protocol (TCP/IP) and similar protocols depicted in accordance with a preferred embodiment of the present invention;

FIG. 6 is a diagram illustrating data flow in transferring data from a source to a destination depicted in accordance with a preferred embodiment of the present invention;

FIG. 7 is an illustration of entries in an ARP table depicted in accordance with a preferred embodiment of the present invention;

FIG. 8 is a flowchart of a process for handling address resolution protocol information for different interfaces depicted in accordance with an illustrative embodiment of the present invention; and

FIG. 9 is an illustration of pseudo code for managing ARP information depicted in accordance with a preferred embodiment of the present invention.

### DETAILED DESCRIPTION OF THE PREFERRED EMBODIMENT

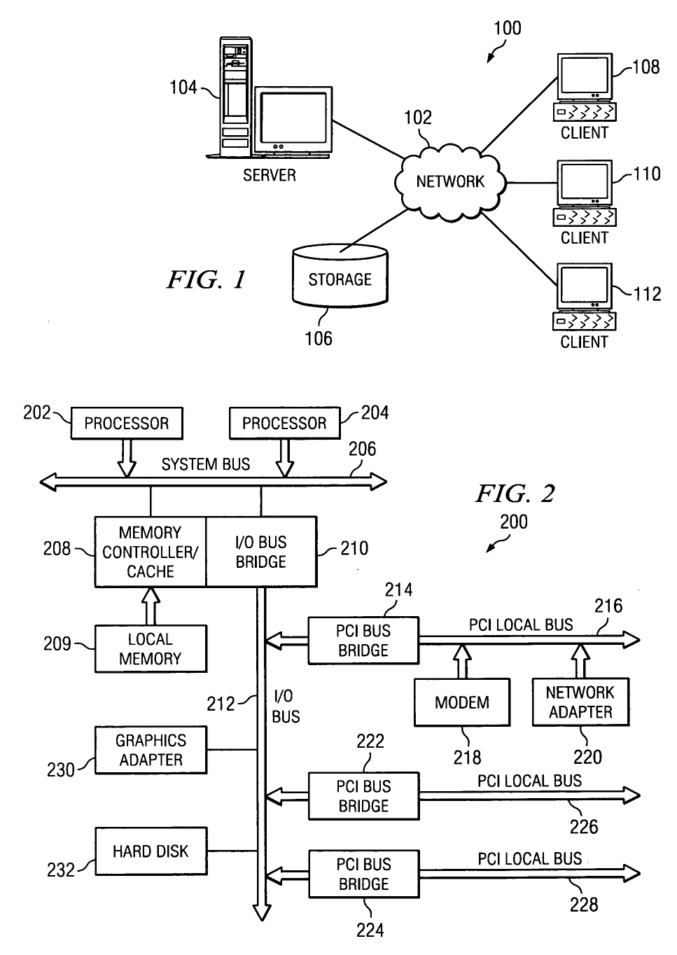

With reference now to the figures, FIG. 1 depicts a pictorial representation of a network of data processing systems in which the present invention may be implemented. Network data processing system 100 is a network of computers in which the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

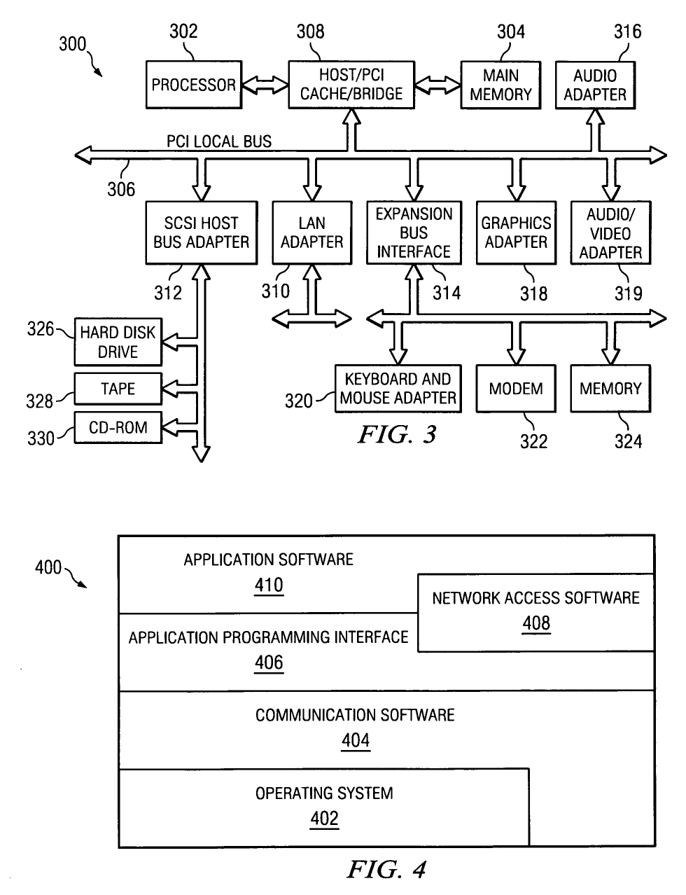

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object-oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Turning to FIG. 4, typical software architecture for a server-client system is depicted in accordance with a preferred embodiment of the present invention. At the lowest level in software architecture 400, operating system 402 is utilized to provide high-level functionality to the user and to other software. Such an operating system typically includes a basic input output system (BIOS). Communication software 404 provides communications through an external port to a network such as the Internet via a physical communications link by either directly invoking operating system functionality or indirectly bypassing the operating system to access the hardware for communications over the network.

Application programming interface (API) 406 allows the user of the system, an individual, or a software routine, to invoke system capabilities using a standard consistent interface without concern for how the particular functionality is implemented. Network access software 408 represents any software available for allowing the system to access a network. This access may be to a network, such as a local area network (LAN), wide area network (WAN), or the Internet. With the Internet, this software may include programs, such as Web browsers.

Application software 410 represents any number of software applications designed to react to data through the communications port to provide the desired functionality the user seeks. Applications at this level may include those necessary to handle data, video, graphics, photos or text, which can be accessed by users of the Internet. The mechanism of the present invention may be implemented within communications software 404 in these examples.

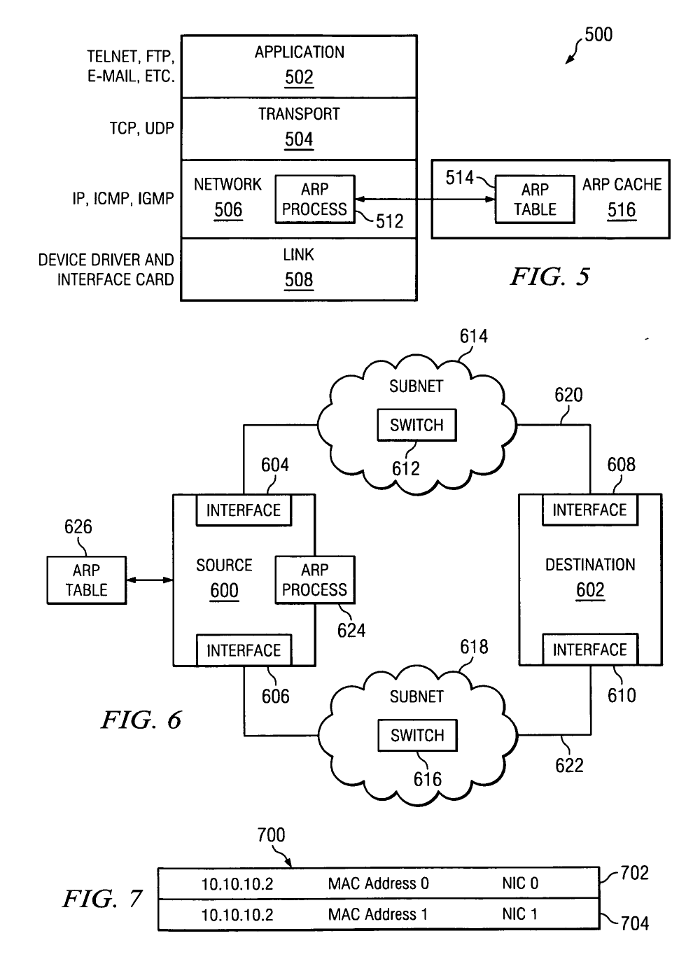

FIG. 5 is a diagram of a transmission control protocol/Internet Protocol (TCP/IP) and similar protocols depicted in accordance with a preferred embodiment of the present invention. TCP/IP and similar protocols are utilized by communications architecture 500. Communications architecture 500 is an example of software that may be found within-communication software 404 in FIG. 4.

In this example, communications architecture 500 is a 4-layer system. This architecture includes application layer 502, transport layer 504, network layer 506, and link layer 508. Each layer is responsible for handling various communications tasks. Link layer 508 also is referred to as the data-link layer or the network interface layer and normally includes the device driver in the operating system and the corresponding network interface card in the computer. This layer handles all the hardware details of physically interfacing with the network media being used, such as optical cables or Ethernet cables.

Network layer 506 also is referred to as the internet layer and handles the movement of packets of data around the network. For example, network layer 506 handles the routing of various packets of data that are transferred over the network. Network layer 506 in the TCP/IP suite is comprised of several protocols, including Internet Protocol (IP), Internet control message protocol (ICMP), and Internet group management protocol (IGMP).

Next, transport layer 504 provides an interface between network layer 506 and application layer 502 that facilitates the transfer of data between two host computers. Transport layer 504 is concerned with things such as, for example, dividing the data passed to it from the application into appropriately sized chunks for the network layer below, acknowledging received packets, and setting timeouts to make certain the other end acknowledges packets that are sent. In the TCP/IP protocol suite, two distinctly different transport protocols are present, TCP and User datagram protocol (UDP). TCP provides reliability services to ensure that data is properly transmitted between two hosts, including dropout detection and retransmission services.

Conversely, UDP provides a much simpler service to the application layer by merely sending packets of data called data grams from one host to the other, without providing any mechanism for guaranteeing that the data is properly transferred. When using UDP, the application layer must perform the reliability functionality.

Application layer 502 handles the details of the particular application. Many common TCP/IP applications are present for almost every implementation, including a Telnet for remote login; a file transfer protocol (FTP); a simple mail transfer protocol (SMTP) for electronic mail; and a simple network management protocol (SNMP).

The mechanism of the present invention may be more specifically implemented in a layer, such as link layer 508. More specifically, the mechanism of the present invention is implemented within ARP process 512. ARP process 512 is in this illustrative example, a network protocol driver. This particular driver contains the processes needed to generate ARP requests and replies. Additionally, ARP process 512 is part of a method, apparatus, and computer instructions for sending data to a destination. When a particular interface, such as a NIC, is selected from a set of interfaces in a data processing system to send data to a destination, a set of address resolution protocol entries located in ARP table 514 within ARP cache 516 are searched for an entry matching an Internet Protocol address for the destination and the particular interface.

In the illustrative examples of the present invention, this search includes both the destination and the interface that is being used to send data. Currently used mechanisms also do not use the interface as part of the process for identifying a MAC address from an ARP cache. In this illustrative example, the destination has the plurality of interfaces using the same Internet Protocol address with each of these interfaces having a different MAC address.

Further, in the illustrative examples, each of these interfaces at the destination also is connected to a different switch on a different subnet. In response to the presence of an entry in ARP table 514 matching the Internet Protocol address and the NIC card at the source, the media access control address in this entry is used to send data to the destination.

If an entry is absent, an ARP request is sent to the destination or broadcast depending on the particular implementation. Responsive to receiving a response to the request, a new entry in the set of entries is generated in which this entry contains the new MAC address obtained from the response. Further, an identification of the interface also is stored with the entry. In this example, the ARP request is sent out on the NIC for which an entry is not present in ARP table 514. In this manner, if a source sending data to a destination through a particular NIC encounters a situation in which the NIC for the MAC address on the destination becomes unavailable or is unavailable, the data transfer may be initiated or continued through another subnet.

Turning now to FIG. 6, a diagram illustrating data flow in transferring data from a source to a destination is depicted in accordance with a preferred embodiment of the present invention. In this illustrative example, source 600 sends data to destination 602. Source 600 and destination 602 are implemented using data processing systems, such as data processing system 200 in FIG. 2 or data processing system 300 in FIG. 3. In this illustrative example of the present invention, source 600 contains two interfaces, interface 604 and interface 606. Destination 602 contains interfaces 608 and 610. In these examples, the interfaces take the form of NICs. Destination 602 assigns a single IP address to both interfaces 608 and 610. In other words, interface 608 and interface 610 both have the same IP address.

Interface 608 is connected to switch 612 on subnet 614. Interface 610 is connected to switch 616 on subnet 618. Source 600 may send data to destination 602 using interface 604, which is connected to switch 612. Further, source 600 also may send data to destination 602 using interface 606, which is connected to switch 616. These two different paths form route 620 and route 622.

Source 600 may choose to send and receive data with destination 602 through route 620 or through route 622. If route 620 is used, interface 604 is employed to transfer data. If route 622 is used, interface 606 is utilized to transfer data to destination 602. If source 600 selects route 620, an ARP request is broadcast over subnet 614 in which this request contains the IP address of destination 602. Destination 602 receives the request on interface 608 and returns the MAC address for interface 608. Source 600 receives a reply at interface 604 and generates an entry in a data structure, such as a table. Of course, these entries may be stored in data structures other than tables. For example, a database, a linked list, or a text file may be used. Previously, these entries only contained the IP address of the destination and the MAC address.

In accordance with an illustrative embodiment of the present invention, ARP process 624 generates an entry in ARP table 626 in which the entry contains the IP address of the destination, the MAC address of the interface at the destination, and an identification of the interface used to broadcast or send the ARP request. In this example, this identification of the interface is an identification of interface 604. This identification may be made using a number of different mechanisms. For example, the MAC address of interface 604 may be used. Alternatively, some other designation may be employed, such as a name provided by the user, or some other designation.

When data is sent by interface 604, ARP process 624 looks up the IP address in ARP table 626 and identifies a MAC address from an entry corresponding to the IP address and interface of the source in these illustrative examples. Previously, the look up consisted only of using the IP address of the destination. If ARP process 624 finds the entry, this entry is returned and used to set transfer data to destination 602.

During the transfer of data from source 600 to destination 602, at some point in time if interface 608 becomes unavailable, packets sent along route 620 are no longer accepted by destination 602. As a result, data may be lost if no acknowledgements are expected. If acknowledgements are expected, a time out may occur after some period of time when acknowledgements to data being sent to destination 602 are no longer received. An interface may be unavailable for a number of different reasons. For example, the software at destination 602 used to process data may no longer be operating. Additionally, the hardware for interface 608 itself may have failed. The connection for interface 608 to switch 612 may have been severed or congestion within subnet 614 may make it impossible for data to reach interface 608.

Previously, source 600 could decide to use route 622 and send data from interface 606 to interface 610. The problem with the currently implemented process is that the entry in an ARP table would only contain the MAC address for interface 608 instead of 610.

The mechanism of the present invention solves this problem by including an identification of the interface at the source within ARP table 626. As a result, if source 600 decides to use interface 606 to send data to destination 602 through route 622, ARP process 624 checks ARP table 626 to determine whether an entry matching both the identification for interface 606 and the IP address for destination 602 are present. If such an entry is present, that MAC address is returned for use to transfer data. Otherwise, ARP process 624 generates an ARP request and sends that request through interface 606 to obtain a reply from destination 602. This ARP reply contains the MAC address for interface 610 and this information is stored within ARP table 626.

Turning now to FIG. 7, an illustration of entries in an ARP table is depicted in accordance with a preferred embodiment of the present invention. In this illustrative example, ARP table 700 is an example of an ARP table, such as ARP table 626 in FIG. 6. Entry 702 contains an IP address, a MAC address, and an interface identification. This particular entry contains an interface identification for an interface, such as interface 604 in FIG. 6. The MAC address in entry 702 is a MAC address for interface 608 in FIG. 6 in this example. The IP address is the IP address for destination 602. In entry 704, the MAC address is for interface 610 and the identification of the interface is for interface 606.

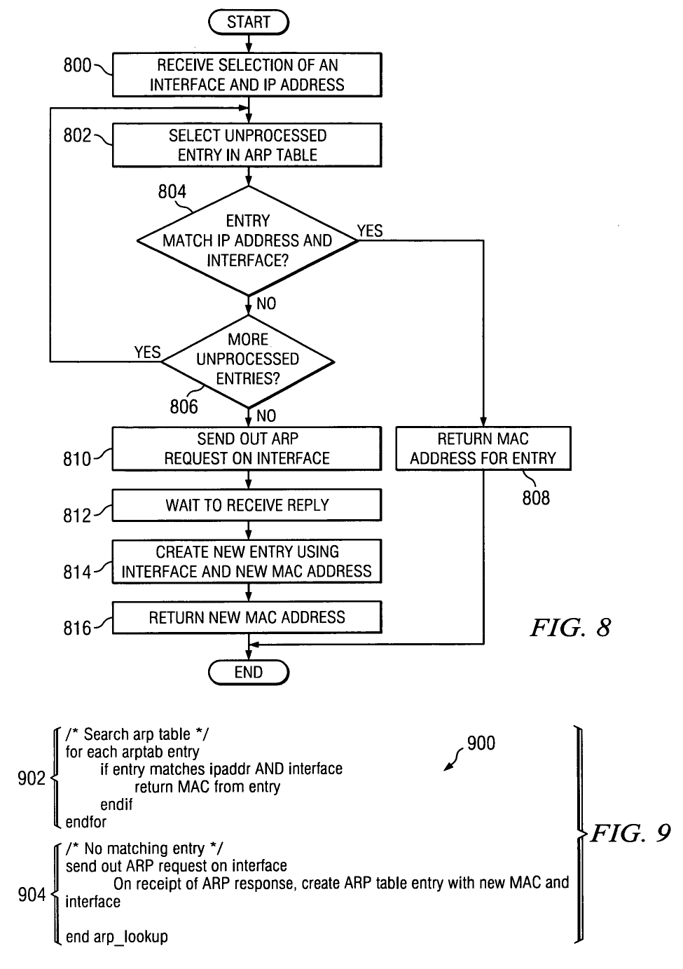

Turning now to FIG. 8, a flowchart of a process for handling address resolution protocol information for different interfaces is depicted in accordance with an illustrative embodiment of the present invention. The process illustrated in FIG. 8 may be implemented in an ARP process, such as ARP process 624 in FIG. 6. This process is employed to identify an appropriate MAC address for a destination when the destination has more than one interface connected to different subnets in which these interfaces are assigned the same IP address.

The process begins by receiving selection of an interface (step 800). Thereafter, an unprocessed entry in the ARP table is selected (step 802). A determination is made as to whether the IP address for the destination and the interface for the source match the selection received (step 804). If a match does not occur, a determination is made as to whether additional unprocessed entries are present in the ARP table (step 806). If additional entries are present, the process returns to step 802.

In step 804, if a match is present, the MAC address for that entry is returned for use in sending data to the destination (step 808) with the process terminating thereafter. With reference again to step 806, if additional unprocessed entries are not present, no entry is present in the ARP table for the particular IP address and interface. At that point, an ARP request is sent out on the selected interface (step 810). The process waits to receive a reply (step 812). When a response is received, a new entry is created in the ARP table in which the entry contains an identification of the interface and the new MAC address received from the reply (step 814). Thereafter, the new MAC address is returned (step 816) with the process terminating thereafter.

Turning next to FIG. 9, an illustration of pseudo code for managing ARP information is depicted in accordance with a preferred embodiment of the present invention. Pseudo code 900 in this illustrative example is an example of code that may be implemented in an ARP process, such as ARP process 620 in FIG. 6. Code 900 is an example of code generated from the process illustrated in FIG. 8 above. Section 902 in code 900 illustrates code for searching an ARP table for an entry that matches both the IP address of the destination and the interface that is to be used to send data to the destination. Section 904 illustrates the generating of a request and receiving of the response for a MAC address when an entry corresponding to both the IP address and the outgoing interface is absent in the ARP table.

Thus, the present invention provides an improved method, apparatus, and computer instructions for handling ARP information for interfaces connected to different switches in which the destination interfaces are assigned the same IP address. The mechanism of the present invention involves including an identification of the outgoing interface along with the destination IP address in the ARP table in storing MAC addresses at the destination. Through this mechanism, lost data and inefficiencies in transferring data from a source to destination may be reduced.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Also, the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for sending data to a destination, the method comprising:
responsive to selecting a particular interface from a set of interfaces in the data processing system to send the data to the destination, searching a set of address resolution protocol entries for an entry matching an Internet Protocol address for the destination and the particular interface, wherein the destination has a plurality of interfaces using the Internet Protocol address with each interface in the plurality of interfaces having a different media access control address; and
responsive to a presence of the entry, using a media access control address in the entry to send the data to the destination.

2. The method of claim 1 further comprising:
responsive to an absence of the entry, sending an address resolution protocol address request to the destination; and
responsive to receiving a response to the request, creating a new entry in the set of entries, wherein the new entry includes a new media access control address from the response and an identification of the interface.

3. The method of claim 1, wherein the set of interfaces are a set of network interface cards.

4. The method of claim 1, wherein the set of address resolution protocol entries are stored in an address resolution protocol table.

5. The method of claim 1 further comprising:
sending data to the destination using each of the plurality of interfaces for the destination.

6. The method of claim 1 further comprising:
selecting the particular interface from the set of interfaces when another interface in the set of interfaces in the data processing system is unavailable.

7. The method of claim 1, wherein each in interface in the set of interfaces in the data processing system corresponds to an interface in the plurality of interfaces in the destination.

8. The method of claim 1, wherein the particular interface is used to send data to a first interface in the plurality of interfaces in which the first interface is connected to a first subnet and wherein another interface in the set of interfaces is used to send data to a second interface in the plurality of interfaces in which the second interface is connected to a second subnet.

9. A computer program product in a system for sending data to a destination, the computer program product comprising:
a computer usable medium having computer usable program code embodied therein;
first computer usable program code, responsive to selecting a particular interface from a set of interfaces in the data processing system to send the data to the destination, for searching a set of address resolution protocol entries for an entry matching an Internet Protocol address for the destination and the particular interface, wherein the destination has a plurality of interfaces using the Internet Protocol address with each interface in the plurality of interfaces having a different media access control address; and
second computer usable program code, responsive to a presence of the entry, for using a media access control address in the entry to send the data to the destination.

10. The computer program product of claim 9 further comprising:
third computer usable program code, responsive to an absence of the entry, for sending an address resolution protocol address request to the destination; and
fourth computer usable program code, responsive to receiving a response to the request, for creating a new entry in the set of entries, wherein the new entry includes a new media access control address from the response and an identification of the interface.

11. The computer program product of claim 9, wherein the set of interfaces are a set of network interface cards.

12. The computer program product of claim 9, wherein the set of address resolution protocol entries are stored in an address resolution protocol table.

13. The computer program product of claim 9 further comprising:
third computer usable program code for sending data to the destination using each of the plurality of interfaces for the destination.

14. The computer program product of claim 9 further comprising:
third computer usable program code for selecting the particular interface from the set of interfaces when another interface in the set of interfaces in the data processing system is unavailable.

15. The computer program product of claim 9, wherein each in interface in the set of interfaces in the data processing system corresponds to an interface in the plurality of interfaces in the destination.

16. The computer program product of claim 9, wherein the particular interface is used to send data to a first interface in the plurality of interfaces in which the first interface is connected to a first subnet and wherein another interface in the set of interfaces is used to send data to a second interface in the plurality of interfaces in which the second interface is connected to a second subnet.

17. A data processing system comprising:
a bus;
a communications unit connected to the bus;
a memory connected to the bus, wherein the memory includes a set of instructions; and
a processor unit connected to the bus, wherein the processor unit executes the set of instructions to search a set of address resolution protocol entries for an entry matching an Internet Protocol address for the destination and the particular interface in response to selecting a particular interface from a set of interfaces in the data processing system to send the data to the destination, wherein the destination has a plurality of interfaces using the Internet Protocol address with each interface in the plurality of interfaces having a different media access control address; and
use a media access control address in the entry to send the data to the destination in response to a presence of the entry.

18. The data processing system of claim 17 in which the processor unit further executes the set of instructions to send an address resolution protocol address request to the destination in response to an absence of the entry; and
create a new entry in the set of entries, wherein the new entry includes a new media access control address from the response and an identification of the interface in response to receiving a response to the request.

19. The data processing system of claim 17, wherein the set of interfaces are a set of network interface cards.

20. The data processing system of claim 17, wherein the set of address resolution protocol entries are stored in an address resolution protocol table.
